(19) United States
(12) Patent Application Publication
(10) Pub. No.: US 2015/0314805 A1
(43) Pub. Date: Nov. 5, 2015

(54) COUPLING ASSEMBLY AND A METHOD OF DECOUPLING A FIRST MEMBER AND A SECOND MEMBER

(71) Applicant: GM GLOBAL TECHNOLOGY OPERATIONS LLC, Detroit, MI (US)

(72) Inventors: Eric B. Hoyer, White Lake, MI (US); William A. Philippin, Ortonville, MI (US)

(73) Assignee: GM GLOBAL TECHNOLOGY OPERATIONS LLC, Detroit, MI (US)

(21) Appl. No.: 14/269,660

(22) Filed: May 5, 2014

(51) Int. Cl. B62D 7/18; B23P 19/04

(52) U.S. Cl. CPC B62D 7/18; B23P 19/04

(57) ABSTRACT

A coupling assembly and a method of decoupling a first member and a second member are disclosed. The assembly includes a first member defining a hole along a central axis and having a hole inner wall extending along the hole and circumscribing the central axis. The assembly also includes a second member defining an aperture that aligns with the hole along the central axis and has an aperture inner wall extending along the aperture and circumscribing the central axis. The assembly further includes a sleeve disposed in the hole and the aperture. The sleeve defines a slit to allow the sleeve to flex. The assembly also includes a pin at least partially disposed inside the sleeve to flex the sleeve outwardly into engagement with the hole inner wall and the aperture inner wall to couple together the first and second members.

### TECHNICAL FIELD

The present disclosure relates to a coupling assembly and a method of decoupling a first member and a second member.

### BACKGROUND

Various components are coupled together utilizing many different methods. For example, a wheel knuckle and a ball joint for a vehicle can be coupled together by press fitting a pin through a hole of the wheel knuckle and a hole of the ball joint. Generally, the pin is formed by precision machining to be press fit to the wheel knuckle and the ball joint. Installation of the press fit pin and removal of the press fit pin from the wheel knuckle and the ball joint can be challenging. Furthermore, precision machining can be costly.

As another example, a threaded sleeve can be welded to a first component. A threaded pin can be screwed into the threaded sleeve to couple a second component to the first component. Regardless of whether there is a slot defined along a length of the sleeve, the sleeve is welded to the first component to maintain its position in order to support another component in a fixed manner. Welding the sleeve to the first component fixes the sleeve thereto to prevent the sleeve from flexing or biasing.

### SUMMARY

The present disclosure provides a coupling assembly including a first member and a second member. The first member defines a hole along a central axis and has a hole inner wall extending along the hole and circumscribing the central axis. The second member defines an aperture that aligns with the hole along the central axis and has an aperture inner wall extending along the aperture and circumscribing the central axis. The assembly further includes a sleeve disposed in the hole and the aperture. The sleeve defines a slit to allow the sleeve to flex. The assembly also includes a pin at least partially disposed inside the sleeve to flex the sleeve outwardly into engagement with the hole inner wall and the aperture inner wall to couple together the first and second members.

The present disclosure also provides a method of decoupling a first member and a second member. The method includes providing the first member and the second member with a sleeve coupling together the first and second members. The method further includes screwing a pin from the sleeve a first predetermined distance to flex at least a portion of the sleeve away from the first and second members while the sleeve continues to couple together the first and second members. The method also includes removing the sleeve from the first and second members by the pin to decouple the first and second members.

The detailed description and the drawings or Figures are supportive and descriptive of the disclosure, but the scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic exploded perspective view of a coupling assembly.

FIG. 2 is a schematic fragmentary cross-sectional view of the coupling assembly.

FIG. 3 is a schematic cross-sectional view of a sleeve and a pin.

FIG. 4 is a schematic perspective view of the sleeve.

FIG. 5 is a schematic enlarged-fragmentary cross-sectional view of the sleeve and the pin.

FIG. 6 is a schematic fragmentary cross-sectional view of a first member and a second member with a tool abutting an end face of the first member to remove the sleeve.

FIG. 7 is a schematic flowchart of a method of decoupling the first member and the second member.

### DETAILED DESCRIPTION

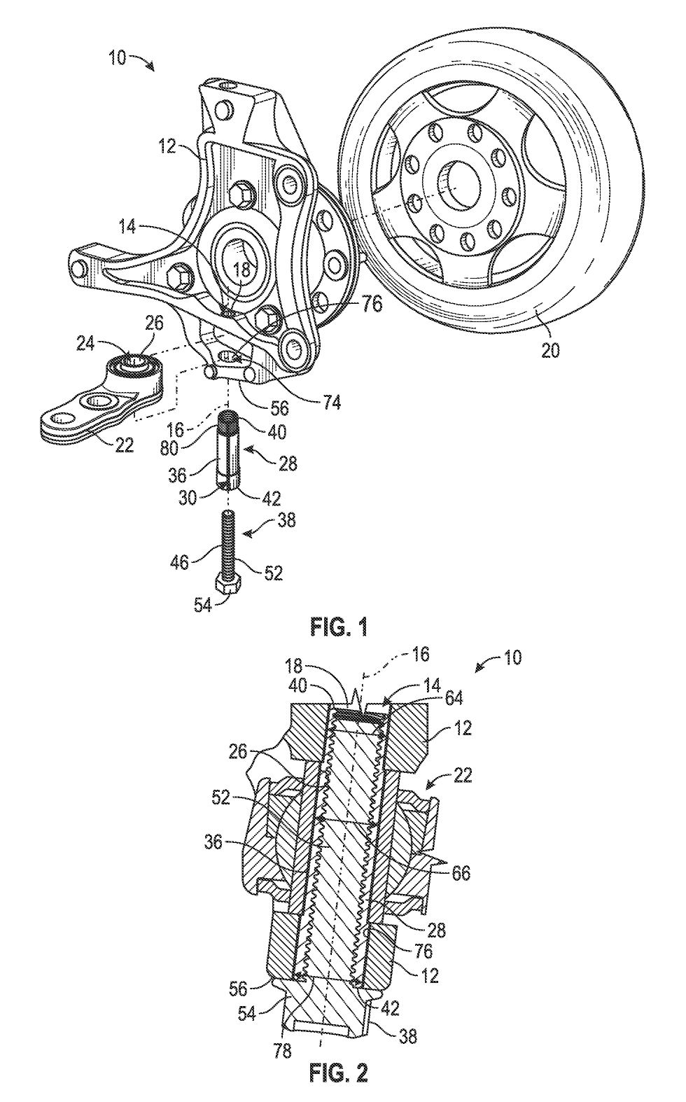

Referring to the Figures, wherein like numerals indicate like or corresponding parts throughout the several views, a coupling assembly 10 is generally shown in FIGS. 1 and 2. The coupling assembly 10 can be utilized in a vehicle, a non-vehicle or any other suitable components that can utilize the coupling assembly 10 as detailed below.

Referring to FIG. 1, the coupling assembly 10 includes a first member 12 defining a hole 14 along a central axis 16 and has a hole inner wall 18 extending along the hole 14 and circumscribing the central axis 16. Said differently, the hole inner wall 18 is disposed radially relative to the central axis 16 such that the wall 18 encircles or circumscribes the central axis 16. As such, the hole inner wall 18 is disposed adjacent to the hole 14. In certain embodiments, the first member 12 can be a wheel knuckle (as shown in FIG. 1) or any other suitable member or component. When the first member 12 is the wheel knuckle, a tire 20 can be rotatably coupled to the wheel knuckle as shown in FIG. 1.

Continuing with FIG. 1, the coupling assembly 10 also includes a second member 22 defining an aperture 24 that aligns with the hole along the central axis 16 and has an aperture inner wall 26 extending along the aperture 24 and circumscribing the central axis 16. Said differently, the aperture inner wall 26 is disposed radially relative to the central axis 16 such that the wall 26 encircles or circumscribes the central axis 16. As such, the aperture inner wall 26 is disposed adjacent to the aperture 24. In certain embodiments, the second member 22 can be a ball joint or any other suitable component. For illustrative purposes only, FIGS. 1 and 2 show the first member 12 as the wheel knuckle and the second member 22 as the ball joint. For example, the wheel knuckle and the ball joint can be utilized in a front wheel steering knuckle, such as in a strut yoke. It is to be appreciated that the coupling assembly 10 can be utilized in applications different from steering knuckle.

Referring to FIG. 2, the coupling assembly 10 further includes a sleeve 28 disposed in the hole 14 and the aperture 24. Also referring to FIG. 4, the sleeve 28 defines a slit 30 to allow the sleeve 28 to flex. Said differently, the slit 30 allows the sleeve 28 to bias. Simply stated, the slit 30 allows movement of the sleeve 28. For example, the sleeve 28 can flex to expand and couple together the first and second members 12, 22, and as another example, the sleeve 28 can flex to retract and decouple the first and second members 12, 22. The sleeve 28 being flexible allows the sleeve 28 to be versatile in light of varying sized holes 14 and varying sized apertures 24. Specifically, the sleeve 28 can compensate for tolerance variations, etc., by being flexible. Furthermore, the sleeve 28 being flexible allows the desired amount of force to be applied to the hole inner wall 18 and the aperture inner wall 26 of the first and second members 12, 22 respectively to couple together the first and second members 12, 22.

Referring to FIGS. 1 and 4, furthermore, the sleeve 28 can define a bore 32 and has an inner surface 34 extending along the bore 32. When the sleeve 28 is disposed in the hole 14 and the aperture 24, the bore 32 is disposed inside the hole 14 and the aperture 24. Generally, the bore 32 aligns with the central axis 16.

The sleeve 28 can also include an outer surface 36 opposing the inner surface 34. Specifically, the inner surface 34 faces the central axis 16 and the outer surface 36 faces away from the central axis 16. The slit 30 is defined through the inner and outer surfaces 34, 36. Therefore, the slit 30 is adjacent to the bore 32.

As shown in FIG. 2, the outer surface 36 faces the hole inner wall 18 and the aperture inner wall 26 of the first and second members 12, 22 respectively when disposed in the hole 14 and the aperture 24. Therefore, when the sleeve 28 flexes outwardly or expands, the outer surface 36 engages the hole inner wall 18 and the aperture inner wall 26 to couple together the first and second members 12, 22.

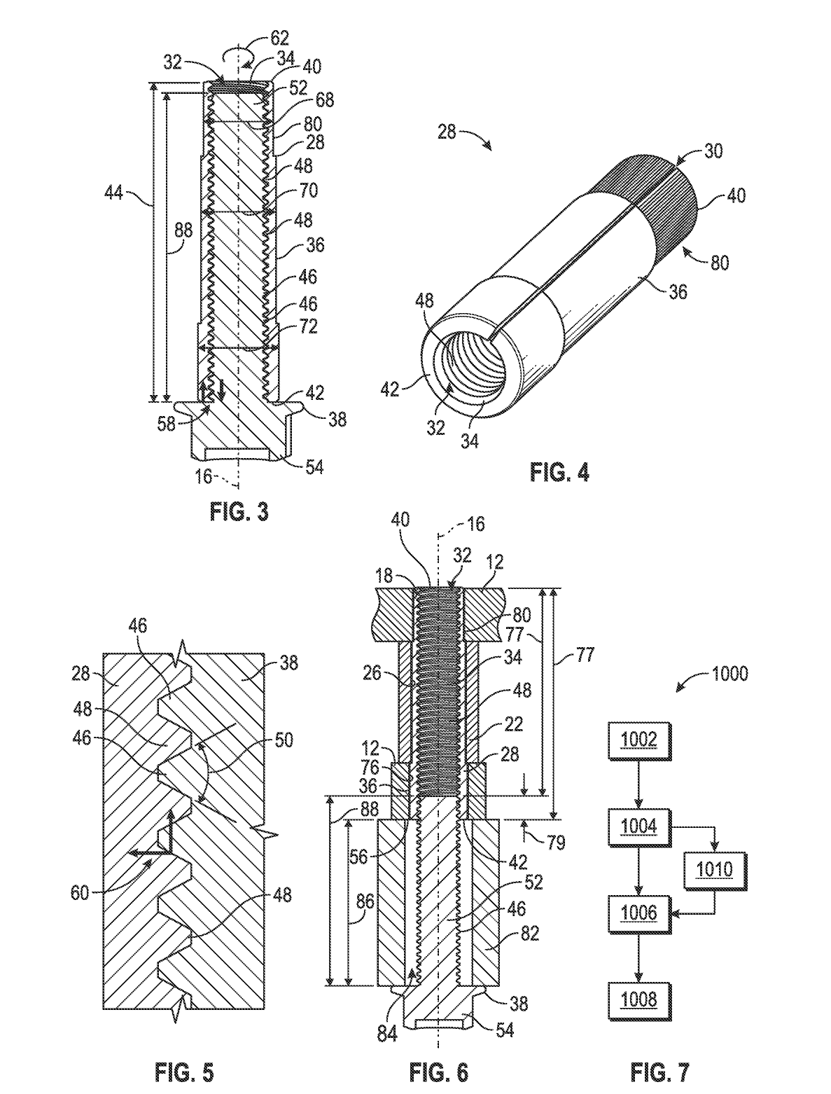

Continuing with FIGS. 2 and 3, the coupling assembly 10 further includes a pin 38 at least partially disposed inside the sleeve 28 to flex the sleeve 28 outwardly into engagement with the hole inner wall 18 and the aperture inner wall 26 to couple together the first and second members 12, 22. Inserting the pin 38 into the sleeve 28 such that the sleeve 28 expands to couple together the first and second members 12, 22 will complete installation. During installation of the sleeve 28 into the hole 14 and the aperture 24, the sleeve 28 can lightly engage the hole inner wall 18 and/or the aperture inner wall 26 to position the sleeve 28 before the pin 38 is inserted into the bore 32 of the sleeve 28.

When the first member 12 is the wheel knuckle and the second member 22 is the ball joint, the sleeve 28 and the pin 38 cooperate to couple together the wheel knuckle and the ball joint. The sleeve 28 and the pin 38 cooperate to couple the first and second members 12, 22 together and counteract a shear load or shear force created between the first and second members 12, 22. Said differently, the sleeve 28 and the pin 38 cooperate to counteract the shear load created during operation of the first and second members 12, 22. Therefore, the pin 38 is inserted into the bore 32 of the sleeve 28 to flex the sleeve 28 outwardly to apply the desired amount of force to the hole inner wall 18 and the aperture inner wall 26 that counteracts the shear load. The pin 38 increases rigidity of the sleeve 28 to maintain the position of the sleeve 28 inside the first and second members 12, 22, and thus, maintain the desired amount of force to counteract the shear load.

The sleeve 28 can be formed of any suitable material that provides rigidity to counteract the shear load applied thereto and flexibility to expand the sleeve 28 to apply the desired amount of force to the walls 18, 26 to counteract the shear load. For example, the sleeve 28 can be formed of a metal material such as steel, an alloy, etc. One suitable alloy is an aluminum alloy. In other embodiments, the sleeve 28 can be formed of a polymeric material having rigidity and flexibility to counteract the shear load.

Referring to FIGS. 3 and 4, the sleeve 28 can further include a first end 40 and a second end 42 spaced from each other along the central axis 16. The sleeve 28 can define a length 44 between the first and second ends 40, 42. The inner and outer surfaces 34, 36 are disposed between the first and second ends 40, 42. Furthermore, in certain embodiments, the slit 30 is defined through the first and second ends 40, 42. Additionally, in certain embodiments, the slit 30 extends the length 44 of the sleeve 28. In one embodiment, the slit 30 extends the entire length 44 of the sleeve 28 as shown in FIG. 4. In certain embodiments, the slit 30 can be spaced from and substantially parallel to the central axis 16 as shown in FIG. 1. Generally, the slit 30 splits the sleeve 28, and more specifically, splits the inner and outer surfaces 34, 36, such that the sleeve 28 is non-continuous. Splitting the sleeve 28 along the length 44 of the sleeve 28 allows the sleeve 28 to flex. It is to be appreciated that the slit 30 can be any suitable configuration to allow flexing of the sleeve 28. The term “substantially” as used herein can refer to a slight imprecision or slight variance of a condition, quantity, value, or dimension, etc., some of which that are within manufacturing variance or tolerance ranges.

As shown in FIGS. 2, 3 and 5, the pin 38 can include a plurality of threads 46. Generally, the threads 46 of the pin 38 face outwardly and can be referred to as external threads. Additionally, the inner surface 34 of the sleeve 28 can include a plurality of threads 48. Generally, the threads 48 of the sleeve 28 face inwardly and can be referred to as internal threads. Therefore, the threads 48 of the sleeve 28 are complementary to the threads 46 of the pin 38 to screw the pin 38 into the sleeve 28 to flex the sleeve 28. Therefore, as the pin 38 is screwed into the sleeve 28, the sleeve 28 expands. Furthermore, as the pin 38 is unscrewed out of the sleeve 28, the sleeve 28 retracts. Optionally, adhesive can be utilized between the threads 46, 48 of the pin 38 and the sleeve 28 to increase radial stiffness.

Referring to FIG. 5, the threads 46 of the pin 38 define a thread angle 50. In certain embodiments, the thread angle 50 can be one of a forty-five degree angle (45° angle) and a sixty degree angle (60° angle). The threads 46 of the pin 38 can be right-handed threads or left-handed threads. Similarly, the threads 48 of the sleeve 28 can be right-handed threads or left-handed threads. The threads 48 of the sleeve 28 complement the threads 46 of the pin 38, and therefore, the threads 48 of the sleeve 28 can be any suitable thread angle 50 to cooperate with the thread angle 50 of the threads 46 of the pin 38. The thread angle 50 can be standard angles, such as the forty-five degree angle (45° angle) or the sixty degree angle (60° angle) as discussed above, to keep costs down. It is to be appreciated that the thread angle 50 can be any desired angle.

Turning to FIGS. 1 and 3, the pin 38 can include a body 52 and a head 54, with the head 54 attached or secured to an end of the body 52. The body 52 can include the plurality of threads 46, and therefore, the threads 46 end or stop adjacent to the head 54. Generally, the head 54 is radially larger than the body 52 so that the head 54 can engage the sleeve 28 and an end face 56 of one of the first and second members 12, 22 when the pin 38 is screwed into the sleeve 28. The head 54 can engage one of the first and second ends 40, 42 of the sleeve 28 as the pin 38 is screwed into the sleeve 28 to create a first force 58 (see FIG. 3), acting on the pin 38 and the sleeve 28 along the central axis 16 which correspondingly creates a force vector 60 (see FIG. 5) that acts on the threads 48 of the sleeve 28 through the threads 46 of the pin 38 being screwed into the sleeve 28 which causes the sleeve 28 to flex outwardly into engagement with the hole inner wall 18 and the aperture inner wall 26. To expand the sleeve 28, the pin 38 is rotated about the central axis 16 into the bore 32 of the sleeve 28. Said differently, as the pin 38 is tightened into the sleeve 28, the pin 38 wants to continue to move axially along the central axis 16 but is restricted due to the head 54 of the pin 38 engaging one of the first and second ends 40, 42 of the sleeve 28 and the end face 56 of one of the first and second members 12, 22 which creates the first force 58 acting on the pin 38 and the sleeve 28 which causes the threads 46 of the pin 38 to apply the force vector 60 to the threads 48 of the sleeve 28 to flex or expand the sleeve 28. In one embodiment, as shown in FIG. 2, the head 54 can engage the second end 42 of the sleeve 28.

Torque 62 (see FIG. 3) is applied to the pin 38 as the head 54 of the pin 38 engages one of the first and second ends 40, 42 of the sleeve 28. The torque 62 increases as the pin 38 is tightened into the sleeve 28 (due to the head 54 of the pin 38 engaging stationary components, i.e., the end face 56 and one of the first and second ends 40, 42 of the sleeve 28) which increases the first force 58 acting on the pin 38 which acts on the sleeve 28. Said differently, the torque 62 creates the first force 58 which acts on or is transferred through the pin 38 and the sleeve 28 along the central axis 16 which correspondingly creates the force vector 60 between the threads 46, 48. Generally, the thread angle 50 of the pin 38 determines the magnitude and direction of the force vector 60. The force vector 60 has a radial force component and an axial force component as shown in FIG. 5, and specifically, the radial force component creates the outward force to flex or expand the sleeve 28. Therefore, as the threads 46, 48 of the pin 38 and the sleeve 28 engage each other, the threads 46 of the pin 38 flex the sleeve 28 outwardly away from the central axis 16 due to thread angle 50 of the pin 38. As such, the thread angle 50 creates the force vector 60 that flexes or expands the sleeve 28 into engagement with the hole inner wall 18 and the aperture inner wall 26 to apply the desired amount of force to the hole inner wall 18 and the aperture inner wall 26. It is to be appreciated that the direction of the torque 62 illustrated in FIG. 3 is one example, and the direction of the torque 62 can be in the opposite direction than illustrated.

Turning to FIG. 2, the hole 14 of the first member 12 has a hole inner diameter 64 and the aperture 24 of the second member 22 has an aperture inner diameter 66. The hole 14 and the aperture 24 can be various configurations, and in various embodiments there can be one or more holes 14 and/or one or more apertures 24. For example, the hole 14 and the aperture 24 can be substantially the same configuration or different configurations. In certain embodiments, the hole inner diameter 64 is less than the aperture inner diameter 66. In other embodiments, the hole inner diameter 64 can be substantially the same as the aperture inner diameter 66. In yet other embodiments, the hole inner diameter 64 is greater than the aperture inner diameter 66. As such, the hole inner diameter 64 and the aperture inner diameter 66 can be any suitable diameter.

The outer surface 36 of the sleeve 28 can be various configurations. For example, in various embodiments, the outer surface 36 can be one outer diameter or two or more different outer diameters. For example, in one embodiment, as shown in FIG. 3, the outer surface 36 of the sleeve 28 has a first outer diameter 68 and a second outer diameter 70. In this embodiment, the outer surface 36 of the sleeve 28 has the first outer diameter 68 complementary to the hole inner diameter 64 and the second outer diameter 70 complementary to the aperture inner diameter 66 such that the sleeve 28 fits inside the hole 14 and the aperture 24. In one embodiment, the first outer diameter 68 is less than the second outer diameter 70. In another embodiment, the first outer diameter 68 is greater than the second outer diameter 70. When the first and second outer diameters 68, 70 are different, the outer surface 36 is stepped as best shown in FIG. 3. In yet another embodiment, the first and second outer diameters 68, 70 are substantially the same.

Continuing with FIG. 3, in another embodiment, the outer surface 36 of the sleeve 28 also has a third outer diameter 72. In certain embodiments, the third outer diameter 72 can be substantially the same as the first and/or second outer diameters 68, 70. In other embodiments, the third outer diameter 72 is different from the first and/or second outer diameters 68, 70. For example, the outer surface 36 of the sleeve 28 can have three different diameters 68, 70, 72. As shown in FIG. 3, the first outer diameter 68 can be less than the second and third outer diameters 70, 72, and the second outer diameter 70 can be less than the third outer diameter 72. Therefore, when the first, second and third outer diameters 68, 70, 72 are different, the outer surface 36 is stepped as best shown in FIG. 3. It is to be appreciated that FIG. 3 is one example, and as mentioned above, the outer diameters 68, 70, 72 can be different than illustrated.

The hole 14 of the first member 12 can be further defined as a first hole 14, the hole inner wall 18 of the first member 12 can be further defined as a first hole inner wall 18 and the hole inner diameter 64 can be further defined as a first hole inner diameter 64. Furthermore, in certain embodiments, as shown in FIGS. 1 and 2, the first member 12 can define a second hole 74 along the central axis 16 and has a second hole inner wall 76 extending along the second hole 74 and circumscribing the central axis 16. Said differently, the second hole inner wall 76 is disposed radially relative to the central axis 16 such that the wall 76 encircles or circumscribes the central axis 16. As such, the second hole inner wall 76 is disposed adjacent to the second hole 74. In this embodiment, the first and second holes 14, 74 can be spaced from each other along the central axis 16 such that the aperture 24 of the second member 22 is disposed between and aligns with the first and second holes 14, 74. Therefore, at least a portion of the second member 22 is disposed between at least a portion of the first member 12. In certain embodiments, the first and second holes 14, 74 and the aperture 24 are coaxial relative to the central axis 16. Additionally, in certain embodiments, the bore 32 of the sleeve 28 can be coaxial relative to the central axis 16, therefore, the sleeve 28 can be disposed between the bore 32 and the first and second hole inner walls 18, 76 and the aperture inner wall 26. It is to be appreciated that the first and second holes 14, 74 and the aperture 24 can be in any suitable location and configuration and FIGS. 1 and 2 are one example. Furthermore, the outer surface 36 of the sleeve 28 can be any suitable configuration to cooperate with the configurations of the first and/or second hole inner walls 18, 76, and the aperture inner wall 26.

Referring to FIG. 2, the second hole inner wall 76 has a second hole inner diameter 78. In this embodiment, the first outer diameter 68 of the outer surface 36 of the sleeve 28 is complementary to the first hole inner diameter 64, the second outer diameter 70 of the outer surface 36 of the sleeve 28 is complementary to the aperture inner diameter 66 such that the sleeve 28 fits inside the first hole 14 and the aperture 24. Furthermore, in this embodiment, the outer surface 36 of the sleeve 28 has the third outer diameter 72 complementary to the second hole inner diameter 78 such that the sleeve 28 fits inside the second hole 74. As discussed above, the outer surface 36 of the sleeve 28 engages the first hole inner wall 18, the second hole inner wall 76 and the aperture inner wall 26 when the pin 38 is screwed into the sleeve 28 to couple together the first and second members 12, 22.

In certain embodiments, as shown in FIG. 2, when utilizing the first and second holes 14, 74 and the aperture 24, the first hole inner diameter 64 is less than the second hole inner diameter 78 and the aperture inner diameter 66. Additionally, the aperture inner diameter 66 is less than the second hole inner diameter 78, and the first outer diameter 68 is less than the second and third outer diameters 70, 72. For clarity, FIG. 2 only identifies the inner diameters 64, 66, 78 of the first and second members 12, 22, i.e., the outer diameters 68, 70, 72 of the sleeve 28 are not identified in this Figure. The outer diameter(s) 68, 70, 72 of the sleeve 28 are generally less than corresponding inner diameter(s) 64, 66, 78 of the first and second members 12, 22 so the sleeve 28 can be inserted into the corresponding hole(s) 14, 74 and the aperture 24.

Turning to FIGS. 1 and 4, the sleeve 28 can include an anti-rotation feature 80 engaging one of the first and second members 12, 22 to minimize rotation of the sleeve 28 when the pin 38 rotates about the central axis 16. In other embodiments, the anti-rotation feature 80 can engage both of the first and second members 12, 22 to minimize rotation of the sleeve 28. Said differently, the anti-rotation feature 80 prevents rotation of the sleeve 28 about the central axis 16 so the pin 38 can be screwed into or unscrewed out of the sleeve 28. Therefore, the pin 38 is rotatable about the central axis 16 while the sleeve 28 remains stationary such that the pin 38 can be torqued in the sleeve 28. As such, the anti-rotation feature 80 provides the reaction force that counteracts the torque 62 being created by rotating the pin 38.

The anti-rotation features 80 can be any suitable configuration and location. FIG. 4 illustrates one example of the configuration and location of the anti-rotation features 80. As shown in FIG. 4, the anti-rotation feature 80 can include a plurality of serrations spaced from each other radially relative to the central axis 16. Alternatively, the anti-rotation feature 80 can be teeth, grooves, splines or any other suitable configuration.

As another example, the anti-rotation feature 80 can be disposed adjacent to one of the first and second ends 40, 42 of the sleeve 28. Specifically, as shown in FIG. 4, the anti-rotation feature 80 can be disposed adjacent to the first end 40 of the sleeve 28. In other embodiments, the anti-rotation feature 80 can be disposed adjacent to the second end 42 of the sleeve 28.

In certain embodiments, the anti-rotation feature 80 is disposed along the outer surface 36 of the sleeve 28. Specifically, as shown in FIG. 4, the outer surface 36 of the sleeve 28 along the first outer diameter 68 can have the anti-rotation feature 80. In other embodiments, the outer surface 36 of the sleeve 28 along the third outer diameter 72 and/or the first outer diameter 68, etc., can have the anti-rotation feature 80. In yet other embodiments, the anti-rotation feature 80 is disposed along the first end 40 of the sleeve 28 and/or disposed along a portion of the outer surface 36 of the sleeve 28.

The sleeve 28 and the pin 38 can reduce manufacturing costs because the sleeve 28 can flex to compensate for tolerance differences. Additionally, securing the sleeve 28 to the first and second members 12, 22 is easier than utilizing a press fit part as discussed in the background section. The sleeve 28 and the pin 38 can be utilized to replace a dowel pin, a spring pin, a roll pin, etc. in various applications. Furthermore, that the sleeve 28 can retract when the pin 38 is unscrewed, disassembly of the first and second members 12, 22 can be easier as discussed further below.

Referring to FIGS. 6 and 7, the present disclosure also provides a method 1000 of decoupling the first member 12 and the second member 22. The method 1000 improves servicing of various components, such as the first and second members 12, 22. For example, decoupling the first and second members 12, 22 is easier when utilizing the sleeve 28 and pin 38 design, which can decrease servicing costs. Furthermore, components, such as the sleeve 28 and/or the pin 38, can be reused or replaced in another assembly after being decoupled from the first and second members 12, 22, which can also reduce costs.

The method 1000 includes providing 1002 the first member 12 and the second member 22 with the sleeve 28 coupling together the first and second members 12, 22. The method 1000 also includes unscrewing 1004 the pin 38 from the sleeve 28 a first predetermined distance 77 (see FIG. 6) to flex at least a portion of the sleeve 28 away from the first and second members 12, 22 while the sleeve 28 continues to couple together the first and second members 12, 22. When the sleeve 28 flexes away from the first and second members 12, 22, the amount of force applied to the inner walls 18, 26, 76 of the first and second members 12, 22 is reduced. Two different first predetermined distances 77 are identified in FIG. 6 for illustrative purposes only and each will be discussed further below.

In certain embodiments, the method 1000 further includes screwing 1006 the pin 38 back into the sleeve 28 a second predetermined distance 79 (see FIG. 6) to secure together the pin 38 and the sleeve 28. Specifically, unscrewing 1004 the pin 38 from the sleeve 28 occurs before screwing 1006 the pin 38 back into the sleeve 28. For example, the pin 38 can be screwed back into the sleeve 28 three or four times a thread pitch of the pin 38. In other words, the pin 38 can be screwed back into the sleeve 28 three or four turns of the pin 38. Generally, removal of the sleeve 28 is easier by minimizing the amount of expansion of the sleeve 28, and therefore, the less distance the pin 38 is screwed back into the sleeve 28 the less the sleeve 28 expands. As such, the pin 38 can be screwed back into the sleeve 28 any suitable second predetermined distance 79 that allows removal of the sleeve 28 from the holes(s) 14, 74 and the aperture 24.

Additionally, the method 1000 includes removing 1008 the sleeve 28 from the first and second members 12, 22 by the pin 38 to decouple the first and second members 12, 22. Specifically, when the sleeve 28 is removed from the hole(s) 14, 74 and the aperture 24, the first and second members 12, 22 can be separated. Removing 1008 the sleeve 28 from the first and second members 12, 22 can occur in various different ways, some of which are discussed below.

In certain embodiments as shown in FIG. 6, the method 1000 utilizes a tool 82 defining an opening 84. The tool 82 presents a length 86 less than a length 88 of the body 52 of the pin 38 such that the pin 38 can be partially screwed back into the sleeve 28. When utilizing the tool 82, the method 1000 includes positioning 1010 the tool 82 along the end face 56 of one of the first and second members 12, 22 such that the sleeve 28 aligns inside the opening 84. To position the tool 82 along the end face 56, the first predetermined distance 77 that the pin 38 is unscrewed is the entire length 44 of the sleeve 28. Simply stated, the pin 38 is completely unscrewed or removed from the sleeve 28 and then the tool 82 is positioned between the end face 56 and the head 54 of the pin 38. Therefore, positioning 1010 the tool 82 along the end face 56 occurs before screwing 1006 the pin 38 back into the sleeve 28. The opening 84 is larger than the outer diameters 68, 70, 72 of the sleeve 28 so the sleeve 28 can move into the opening 84, or retract into the opening 84, without engaging the tool 82. For illustrative purposes only, FIG. 6 shows the end face 56 along the first member 12.

Furthermore, in the embodiment of FIG. 6, screwing 1006 the pin 38 back into the sleeve 28 further includes disposing the pin 38 through the opening 84 of the tool 82 and screwing the pin 38 into the sleeve 28 until the head 54 of the pin 38 engages the tool 82. Additionally, in this embodiment, removing 1008 the sleeve 28 from the first and second members 12, 22 by the pin 38 further includes continuing to screw the pin 38 into the sleeve 28 which causes the sleeve 28 to retract along the pin 38 and into the opening 84 of the tool 82. The pin 38 can be rotated until the anti-rotation features 80 disengage from one of the first and second members 12, 22, and once this occurs, if the sleeve 28 is not removed from the hole(s) 14, 74 and/or the aperture 24, the pin 38 can be pulled to remove the sleeve 28 from the first and second members 12, 22.

In other embodiments, the tool 82 is not utilized in the method 1000. In one such embodiment, removing 1008 the sleeve 28 from the first and second members 12, 22 by the pin 38 further includes pulling the pin 38 to remove the sleeve 28 from the first and second members 12, 22. When the tool 82 is eliminated in the method 1000, the pin 38 can be, but does not have to be, completely unscrewed or removed from the sleeve 28. Therefore, the first predetermined distance 77 can be less than the entire length 44 of the sleeve 28 (i.e., the pin 38 is not completely removed from the sleeve 28); as such, the method 1000 can eliminate screwing 1006 the pin 38 back into the sleeve 28 the second predetermined distance 79. Alternatively, the pin 38 can be completely unscrewed or removed from the sleeve 28 such that the first predetermined distance 77 is the entire length 44 of the sleeve 28; and in this alternative, the method 1000 includes screwing 1006 the pin 38 back into the sleeve 28 the second predetermined distance 79. As yet another alternative, the first predetermined distance 77 can be less than the entire length 44 of the sleeve 28 (i.e., the pin 38 is not completely removed from the sleeve 28); and in this alternative, the method 1000 can include screwing 1006 the pin 38 back into the sleeve 28 the second predetermined distance 79.

It is to be appreciated that the order or sequence of performing the method 1000 as identified in the flowchart of FIG. 7 is for illustrative purposes and other orders or sequences are within the scope of the present disclosure. It is to also be appreciated that the method 1000 can include other features not specifically identified in the flowchart of FIG. 7.

While the best modes for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A coupling assembly comprising:
a first member defining a hole along a central axis and having a hole inner wall extending along the hole and circumscribing the central axis;
a second member defining an aperture that aligns with the hole along the central axis and having an aperture inner wall extending along the aperture and circumscribing the central axis;
a sleeve disposed in the hole and the aperture, with the sleeve defining a slit to allow the sleeve to flex; and
a pin at least partially disposed inside the sleeve to flex the sleeve outwardly into engagement with the hole inner wall and the aperture inner wall to couple together the first and second members.

2. An assembly as set forth in claim 1 wherein the sleeve defines a bore and having an inner surface extending along the bore, with the sleeve including an outer surface opposing the inner surface, with the outer surface facing the hole inner wall and the aperture inner wall of the first and second members respectively when disposed in the hole and the aperture, and wherein the slit is defined through the inner and outer surfaces.

3. An assembly as set forth in claim 2 wherein the sleeve includes a first end and a second end spaced from each other along the central axis and the inner and outer surfaces are disposed between the first and second ends, with the slit defined through the first and second ends.

4. An assembly as set forth in claim 3 wherein the pin includes a plurality of threads and the inner surface of the sleeve includes a plurality of threads complementary to the threads of the pin to screw the pin into the sleeve to flex the sleeve.

5. An assembly as set forth in claim 4 wherein the pin includes a head engaging one of the first and second ends of the sleeve as the pin is screwed into the sleeve to create a first force acting on the pin and the sleeve along the central axis which correspondingly creates a force vector that acts on the threads of the sleeve through the threads of the pin being screwed into the sleeve which causes the sleeve to flex outwardly into engagement with the hole inner wall and the aperture inner wall.

6. An assembly as set forth in claim 4 wherein the threads of the pin define a thread angle, and wherein the thread angle is one of a 45 degree angle and a 60 degree angle.

7. An assembly as set forth in claim 1 wherein the hole of the first member has a hole inner diameter and the aperture of the second member has an aperture inner diameter, and wherein the sleeve includes an outer surface that has a first outer diameter complementary to the hole inner diameter and a second outer diameter complementary to the aperture inner diameter such that the sleeve fits inside the hole and the aperture.

8. An assembly as set forth in claim 7 wherein the hole inner diameter is less than the aperture inner diameter, and wherein the first outer diameter is less than the second outer diameter.

9. An assembly as set forth in claim 7:
wherein the hole of the first member is further defined as a first hole and the hole inner wall of the first member is further defined as a first hole inner wall, and the hole inner diameter is further defined as a first hole inner diameter;
wherein the first member defines a second hole along the central axis and having a second hole inner wall extending along the second hole and circumscribing the central axis, with the first and second holes spaced from each other along the central axis such that the aperture of the second member is disposed between and aligns with the first and second holes, and with the second hole inner wall having a second hole inner diameter;
wherein the first outer diameter of the outer surface of the sleeve is complementary to the first hole inner diameter, the second outer diameter of the outer surface of the sleeve is complementary to the aperture inner diameter such that the sleeve fits inside the first hole and the aperture; and
wherein the outer surface of the sleeve has a third outer diameter complementary to the second hole inner diameter such that the sleeve fits inside the second hole.

10. An assembly as set forth in claim 9 wherein:
the first hole inner diameter is less than the second hole inner diameter and the aperture inner diameter;
the aperture inner diameter is less than the second hole inner diameter;
the first outer diameter is less than the second and third outer diameters; and
the second outer diameter is less than the third outer diameter.

11. An assembly as set forth in claim 1 wherein the sleeve includes an anti-rotation feature engaging one of the first and second members to minimize rotation of the sleeve when the pin rotates about the central axis.

12. An assembly as set forth in claim 11 wherein the anti-rotation feature includes a plurality of serrations spaced from each other radially relative to the central axis.

13. An assembly as set forth in claim 11 wherein the sleeve includes a first end and a second end spaced from each other along the central axis, with the slit defined through the first and second ends, and wherein the anti-rotation feature is disposed adjacent to one of the first and second ends.

14. An assembly as set forth in claim 11 wherein the sleeve defines a bore and having an inner surface extending along the bore, with the sleeve including an outer surface opposing the inner surface, and wherein the anti-rotation feature is disposed along the outer surface of the sleeve.

15. An assembly as set forth in claim 1 wherein the first member is a wheel knuckle and the second member is a ball joint.

16. A method of decoupling a first member and a second member, the method comprising:
providing the first member and the second member with a sleeve coupling together the first and second members;
unscrewing a pin from the sleeve a first predetermined distance to flex at least a portion of the sleeve away from the first and second members while the sleeve continues to couple together the first and second members; and
removing the sleeve from the first and second members by the pin to decouple the first and second members.

17. A method as set forth in claim 16 further comprising positioning a tool, which defines an opening, along an end face of one of the first and second members such that the sleeve aligns inside the opening, and screwing the pin back into the sleeve a second predetermined distance to secure together the pin and the sleeve.

18. A method as set forth in claim 17 wherein screwing the pin back into the sleeve further comprises disposing the pin through the opening of the tool and screwing the pin into the sleeve until a head of the pin engages the tool.

19. A method as set forth in claim 18 wherein removing the sleeve from the first and second members by the pin further comprises continuing to screw the pin into the sleeve which causes the sleeve to retract along the pin and into the opening of the tool.

20. A method as set forth in claim 16 wherein removing the sleeve from the first and second members by the pin further comprises pulling the pin to remove the sleeve from the first and second members.
